(19) United States
(12) Patent Application Publication
(10) Pub. No.: US 2006/0063059 A1
(43) Pub. Date: Mar. 23, 2006

(54) AMORPHOUS, NON-OXIDE SEALS FOR SOLID ELECTROLYTE OR MIXED ELECTROLYTE CELLS

(75) Inventors: Charles Arthur Lewinsohn, Salt Lake City, UT (US); Kerri L. Cameron, Lehi, UT (US); Dennis LeRoy Larsen, West Valley City, UT (US)

Correspondence Address: CERAMATEC, INC., 2425 SOUTH 900 WEST, SALT LAKE CITY, UT, 84119, US

(73) Assignee: CERAMATEC, INC., Salt Lake City, UT (US)

(21) Appl. No.: 11/160,622

(22) Filed: Jun. 30, 2005

Related U.S. Application Data
(60) Provisional application No. 60/521,776, filed on Jul. 1, 2004.

(51) Int. Cl. H01M 2/08; F16J 15/10

(52) U.S. Cl. 429/36; 277/312; 277/650

(57) ABSTRACT

A seal located between ceramic electrolyte or mixed electrolyte cells, and ceramic components of similar or dissimilar compositions, ceramic components and metal components, or any other materials for use in electrochemical gas separation devices, fuel cells and other thermal electrochemical power generation devices, high temperature heat exchangers, thermal management devices or other applications requiring joining or gas-tight bonding where said seal is comprised of materials derived from pyrolysis of silicocarbon polymers and fillers of active and/or passive fillers.

### CROSS-REFERENCE TO RELATED APPLICATIONS

This application claims priority to U.S. Provisional Patent Application Ser. No. 60/521,776, filed on Jul. 1, 2005, which is incorporated herein by reference.

### BACKGROUND OF INVENTION

Solid Oxide Fuel Cells (SOFC) convert chemical energy to electrical energy directly from a variety of fuels, and thus offer the potential for high-efficiency stationary and mobile power generation with lower emissions than current, commercial power systems. Planar, solid electrolyte or mixed electrolyte cell designs offer high power density per unit volume and lower manufacturing costs than other designs. In planar solid electrolyte or mixed electrolyte cell designs a seal is required to prohibit fuel and air from mixing and decreasing the oxygen gradient required for operation. These seals must be thermomechanically stable at high temperatures (700-850° C.), be highly impermeable (in order to prevent mixing of the reducing and oxidizing atmospheres), be chemically compatible with the other solid electrolyte or mixed electrolyte cell materials, have a similar coefficient of thermal expansion (CTE) to the materials against which they seal, and be electrically insulating. Current seals do not meet the performance criteria for commercially viable SOFC systems. In particular, seal materials and designs that are capable of allowing cells and stacks to survive planned and unplanned thermal cycles, are compatible with solid electrolyte or mixed electrolyte cell component materials and environments, are mechanically and chemically stable for the projected lifetime of a commercial SOFC (40,000 h for stationary systems, or at least 5,000 h and 3,000 thermal cycles for transportation systems), and can be fabricated cost-effectively must be developed in order for systems utilizing SOFCs for power generation to be viable.

In a Phase I SBIR program, funded by the US Department of Energy, Ceramatec developed an amorphous, non-oxide material and demonstrated:
a) chemical stability of the material in SOFC environments;
b) the ability to tailor the coefficient of thermal expansion of the seal material;
c) compatibility with fuel cell materials; and
d) limited degradation of seals after thermal cycling.

### BRIEF DESCRIPTION OF THE DRAWINGS

FIG. 1 shows an apparatus used to expose samples to reduce conditions and for button cell seal testing.

FIG. 2 is a graph depicting cell performance with and without seal materials in a fuel side environment.

FIG. 3 is a graph depicting leak rate as a function of thermal cycles for one seal.

FIG. 4a is a top view of a button cell sealed onto a zirconia tub using an amorphous, non-oxide seal obtained by pryolysis of a perceramic precursor polymer.

FIG. 4b is a rear view of a button cell sealed onto a zirconia tub using an amorphous, non-oxide seal obtained by pryolysis of a perceramic precursor polymer.

### DETAILED DESCRIPTION

This invention relates to both a process for obtaining durable, seals for planar solid electrolyte or mixed electrolyte cell stacks, solid electrolyte cell stacks, and mixed electrolyte stacks and to seals for use in SOFC environments. The basis of the invention is to form seals, comprised mainly of a non-oxide phase, by pyrolysis of preceramic precursor polymers containing fillers, used to control physical properties. Non-oxide materials offer the potential for chemically stable and mechanically durable seals. Fabrication of the seals from polymer precursors provides flexible processing opportunities compatible with solid electrolyte or mixed electrolyte cell stack fabrication. For example, precursors are available in liquid form, or can be dispersed in a solvent, with viscosities that allow the seal material to conform to surface features in the substrate. Seal compositions and processing methods can be modified to meet solid electrolyte or mixed electrolyte cell stack performance criteria. Filler materials can be used to tailor the physical properties, such as the coefficient of thermal expansion and compliance of seal materials that exhibit good adhesion to relevant solid electrolyte or mixed electrolyte cell materials (i.e. interconnect and electrolyte materials), so as to avoid the development of stresses during the lifetime of a solid electrolyte or mixed electrolyte cell.

Studies have been conducted using seals comprised of non-oxide materials containing various fillers and the following were demonstrated:
1. the ability to tailor the coefficient of thermal expansion of the seal material;
2. chemical stability of the material in SOFC environments;
3. compatibility with fuel cell materials;
4. limited degradation of seals after thermal cycling; and
5. promising leak rate results.

Elemental metal fillers that had melting temperatures greater than 1000° C. and CTE values such that a composite CTE value (based on the rule of mixtures of volume) of approximately 10×10⁻⁶ C⁻¹ could be obtained with 30-50%, by volume, of filler were selected. The fillers that were selected were iron (Fe), nickel (Ni), copper (Cu), and manganese (Mn). In addition, yttrium-doped zirconia was evaluated as a filler, since it was expected that it might promote adhesion of the non-oxide based seal material to zirconia electrolyte material. In addition, submicron-sized silicon carbide (SiC) was also used as a filler.

Bar shaped specimens consisting of baseline seal material (partially pyrolysed polymer and fresh polymer in a four parts, by weight, to one, respectively, ratio) with 30 percent volume fraction of the various fillers were pressed and subsequently pyrolysed at 900° C. for 4 hours. The CTE of the specimens was measured using pushrod dilatometers, in air or argon. The data in Table 1 shows that not only is it possible to modify the thermal expansion of the seal material through the use of appropriate fillers, but that values of CTE that are close to those of relevant solid electrolyte or mixed electrolyte cell materials can be obtained.

A study of the environmental stability of potential seal materials was conducted. Two types of environmental testing were performed since seal materials will be exposed to both oxidizing and reducing conditions. To study the effects of oxidizing conditions, bar shaped specimens of seal materials were placed inside a clamshell furnace and heated to 950° C. and held for 150 or 500 h. During the exposure moist air was fed into the furnace. The air was bubbled through water held at 60° C. to obtain gas with approximately 15 mol % water. This is a higher concentration of water and higher temperature than anticipated in an SOFC and, therefore, the test is an accelerated study of environmental effects. Prior to and subsequent to exposure, the dimensions and weights of the samples were measured. The specimens were investigated after exposure using scanning electron microscopy (SEM).

TABLE 1
CTE of samples measured in air

| | Temperature | |
|---|---|---|
| Composition | Range (° C.) | CTE (ppm ° C.⁻¹) |
| 8 mol % yttium-doped zirconia | 25-1000 | 10.6-11.1 |
| aHPCS/30 vol % Fe | 200-700 | 10.0 |
| aHPCS/30 vol % Cu | 200-700 | 7.0 |
| aHPCS/30 vol % Ni | 200-700 | 9.0 |
| aHPCS/30 vol % SiC | 200-700 | 3.0 |
| aHPCS/30 vol % yttrium-doped ZrO₂ | 200-700 | 7.0 |
| aHPCS/30 vol % Sandia glass #31 | 200-600 | 7.0 |
| KiON/14 vol % Fe | 200-600 | 5.0 |
| KiON/30 vol % Fe | 200-600 | 10.0 |
| KiON/30 vol % Cu | 200-700 | 5.0 |
| KiON/30 vol % Ni | 200-700 | 10 |
| KiON/30 vol % SiC | 200-700 | 3.0 |
| KiON/30 vol % yttrium-doped ZrO₂ | 200-700 | 8.0 |

Despite the wide scatter in weight change results, due to systematic errors, microscopic investigations suggest that the material derived from polymer precursors is stable in both oxidizing and reducing conditions. Furthermore, the potential seal compositions appear to be stable in reducing conditions: changes in the seal material microstructure could not be detected visually using SEM. In oxidizing conditions, seal compositions containing yttrium-doped zirconia and silicon carbide appear to have very low oxidation rates. Compositions containing metal fillers, on the other hand, show the formation of oxidation products. Nickel is not an appropriate filler due to its fast oxidation rate. Iron, on the other, hand oxidized much more slowly. This is fortuitous, since iron can be used to provide desirable CTE values.

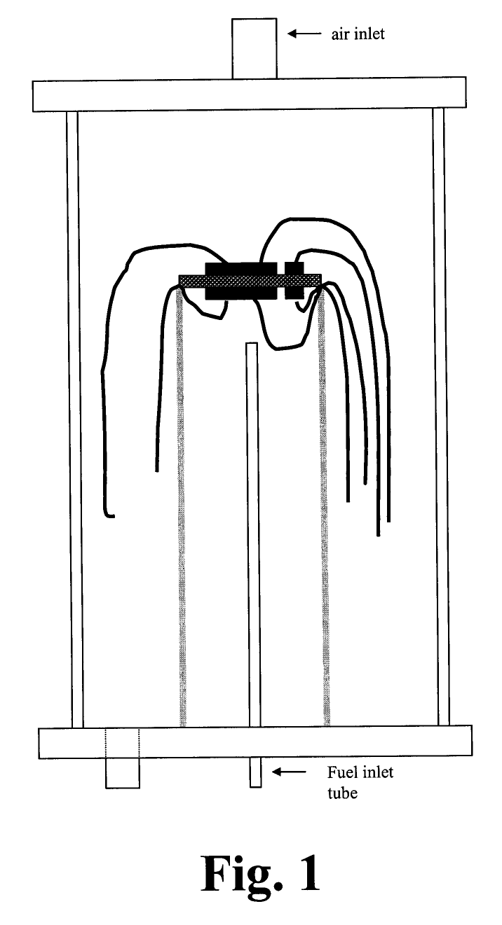

In addition to examining the stability of the potential, amorphous, non-oxide seal materials in environments relevant to SOFCs, experiments were performed to determine whether the presence of the potential seal materials would adversely impact SOFC performance. Theses tests were similar to those used for evaluating the stability of materials in reducing conditions: bar-shaped specimens of potential seal materials were attached to the fuel inlet tube in a button cell test apparatus and the fuel cell was operated for approximately 100 h. These apparatus consist of a small, disc shaped SOFC sealed to a zirconia support tube that was placed inside a high temperature furnace. For these experiments a glass seal was used to seal the SOFC to the support since the amorphous, non-oxide seals were still under development. The support tube was placed within the furnace and its open end passed out of the hot zone so that it could be sealed to a metal end-cap (FIG. 1). An alumina tube with a diameter smaller than the support tube entered the end cap and supplied fuel to the anode. The cathode was exposed to ambient air inside the furnace.

To characterize the intrinsic degradation of the cells that were being used, initially the cell was run without any samples on the fuel side. Subsequently, specimens of seal material were placed on the fuel inlet tube and the cell was run under load for approximately 100 h. To determine whether any degradation that was observed was due to cell characteristics or the effects of the specimens, the cell was operated under load again without any samples. This process was iterated up to six times.

TABLE 2
Compositions of seal materials in fuel side environment during
SOFC testing

| Composition | Cell Number | Cycle Number |
|---|---|---|
| aHPCS/30 vol % Cu | 1 | 1 |
| aHPCS/30 vol % SiC | 1 | 1 |
| aHPCS/30 vol % yttrium-doped ZrO₂ | 1 | 1 |
| KiON/30 vol % SiC | 1 | 2 |
| KiON/30 vol % Fe | 1 | 2 |
| KiON/30 vol % Ni | 1 | 2 |
| none | 2 | 1 |
| aHPCS/30 vol % Cu | 2 | 2 |
| aHPCS/30 vol % SiC | 2 | 2 |
| aHPCS/30 vol % Ni | 2 | 2 |
| none | 2 | 3 |
| aHPCS/30 vol % yttrium-doped ZrO₂ | 2 | 4 |
| aHPCS/30 vol % Fe | 2 | 4 |
| none | 2 | 5 |
| aHPCS/30 vol % Fe | 2 | 6 |
| aHPCS/30 vol % Cu | 2 | 6 |
| none | 3 | 1 |
| KiON/30 vol % Cu | 3 | 2 |
| KiON/30 vol % yttrium-doped ZrO₂ | 3 | 2 |
| none | 3 | 3 |
| KiON/30 vol % Cu | 3 | 4 |
| KiON/30 vol % Fe | 3 | 4 |

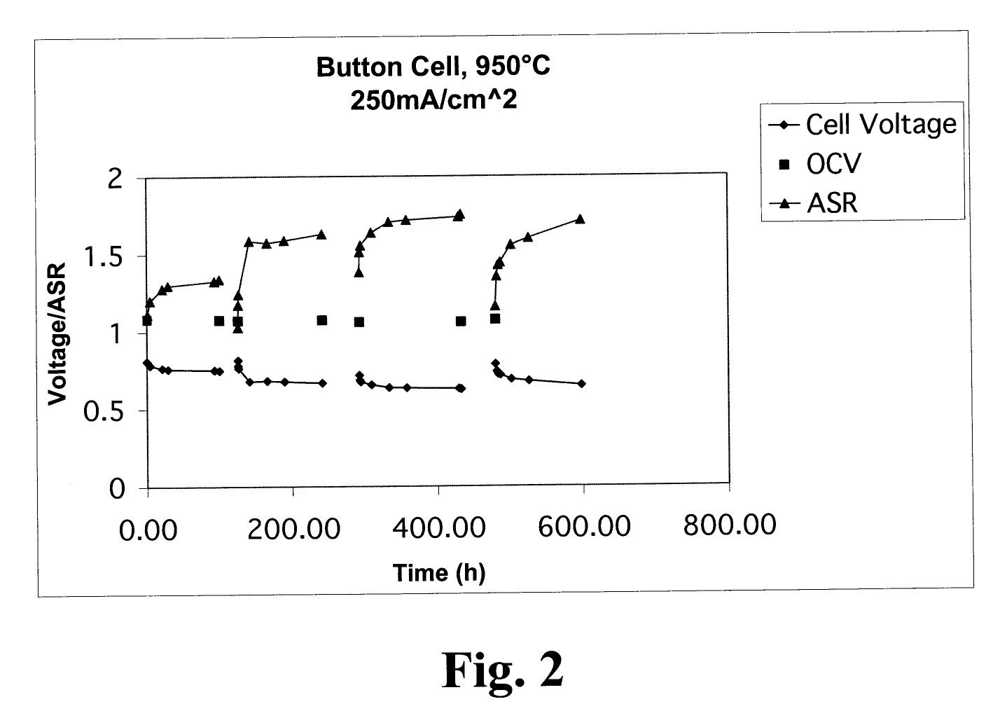

As shown in FIG. 2, the presence of potential seal materials on the fuel side of the cell did not affect the performance of the cells used. Table 2 lists the compositions of the materials that were attached to the fuel inlet tube during various cycles. Based on the results of these experiments, the potential, amorphous, non-oxide seal materials do not appear to affect processes occurring on the anode side of the SOFC.

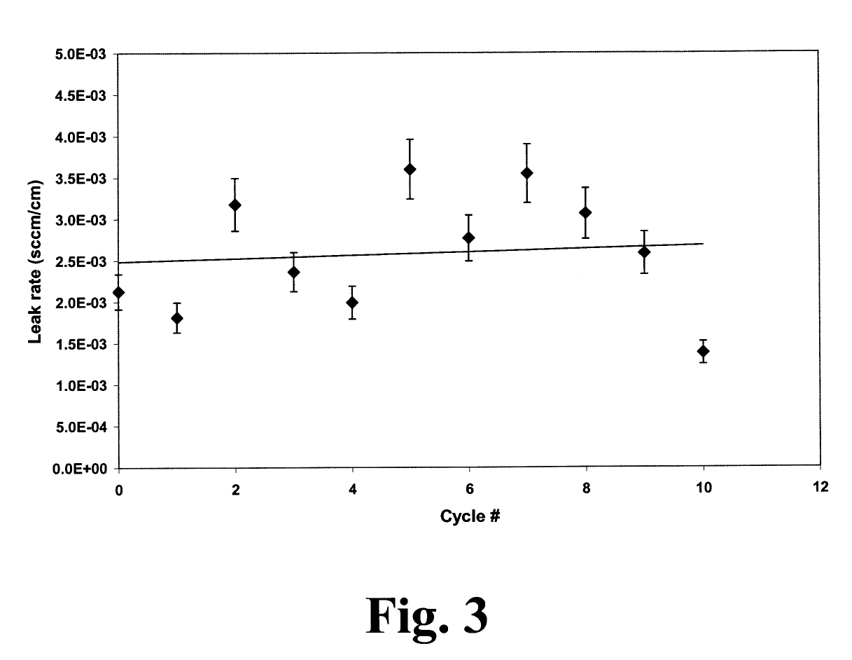

The seal between zirconia-based electrolyte parts that exhibited the best leak rate was subject to a series of thermal cycles. The thermal cycles involved heating the specimen to 800° C. in 8 h and then cooling to room temperature in 8 h. The leak rate of the seal was relatively constant as shown in FIG. 3. The line shown in FIG. 3 indicates a least square regression to the data. The leak rate per cycle was approximately 1% of the actual leak rate. In addition, the substrates did not crack and the minimal leak rate degradation per cycle indicates that the seal material remained robust. This demonstrates both good adhesive properties of the seals and thermomechanical match between the seals and zirconia-based electrolyte such that neither seals nor electrolyte failed due to cycling. These results are perhaps the most significant demonstration of the feasibility of using amorphous, non-oxide materials as seals in solid electrolyte or mixed electrolyte cells.

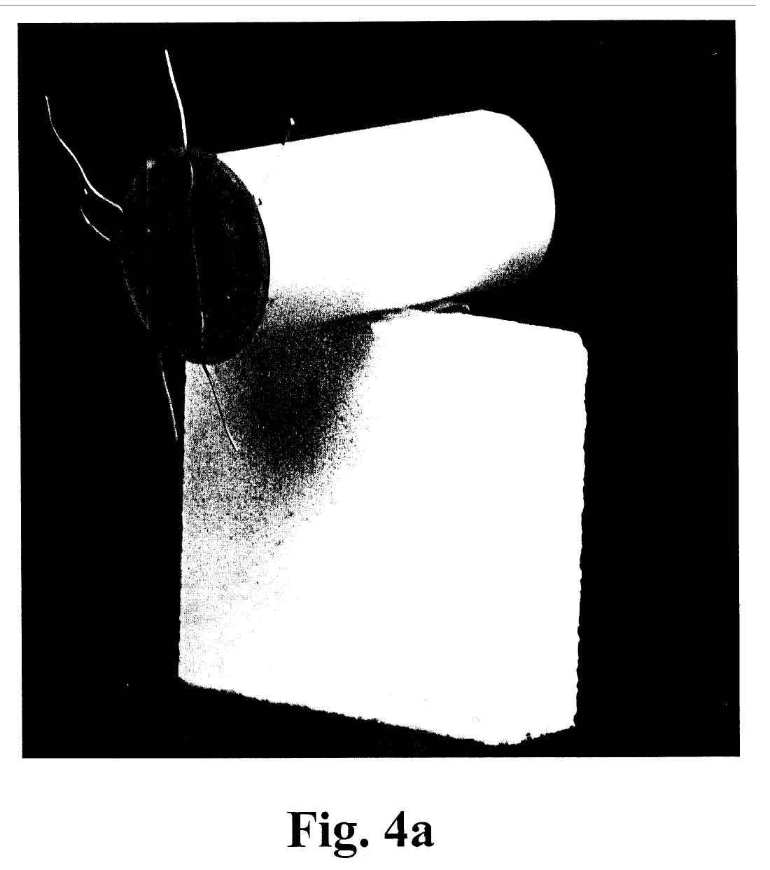

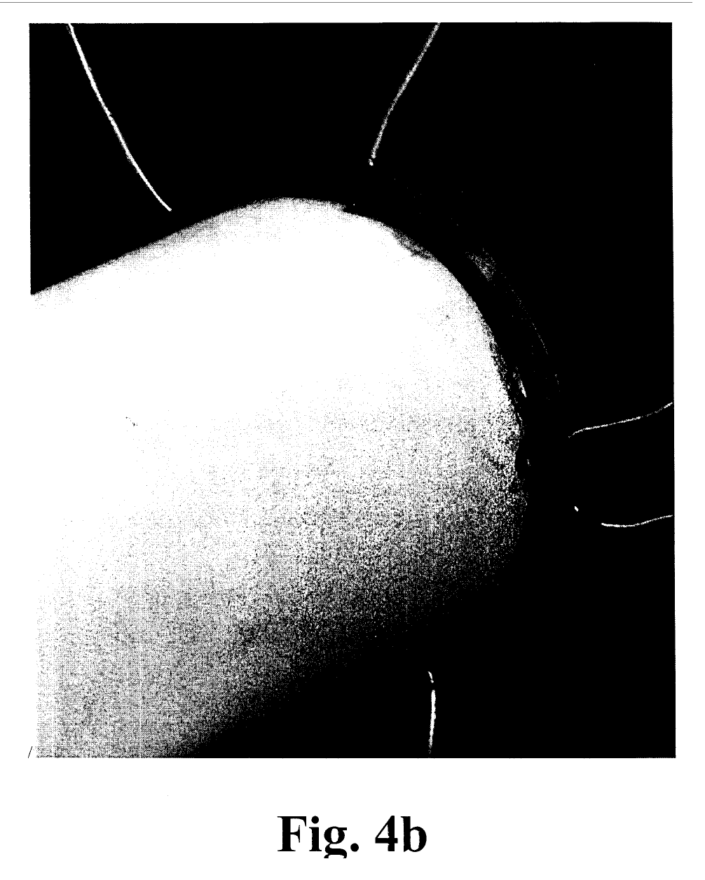

Two button cell SOFCs were sealed to zirconia tubes using seal materials with different fillers (FIG. 4a-b). The cells were heated inside the test apparatus and the open circuit voltage (OCV) was measured as a function of temperature. The results are shown in Table 3. The results indicate that there are minimal leaks in the system until between circuit voltage (OCV) was measured as a function of temperature. The results are shown in Table 3. The results indicate that there are minimal leaks in the system until between 800° C. and 850° C. for the seal with the metal filler and above 850° C. for the seal with the ceramic filler. Furthermore, these cells were cooled to room temperature and reheated, the heating and cooling rate were approximately 2° C./min. The OCV results after thermal cycling of the button cells were similar to those measured after the initial heat up. These results indicate that not only do the seals provide an acceptable leak rate for cell operation, but that they can also perform after thermal cycling.

TABLE 3
OCV values for sealed button cells

| Temperature (° C.) | aHPCS + metal filler | | aHPCS + ceramic filler | |
|---|---|---|---|---|
| 600 | 1.096 | V | 1.106 | V |
| 650 | 1.085 | V | 1.098 | V |
| 675 | 1.078 | V | 1.094 | V |
| 700 | 1.073 | V | 1.089 | V |
| 725 | 1.067 | V | 1.084 | V |
| 750 | 1.063 | V | 1.078 | V |
| 800 | 1.038 | V | 1.065 | V |
| 850 | 1.030 | V | 1.052 | V |
| 900 | 1.008 | V | 1.042 | V |

cooled to 50° C.

| | | |
|---|---|---|
| 600 | 1.085 | 1.112 |
| 650 | 1.077 | 1.014 |
| 700 | 1.067 | 1.095 |
| 725 | 1.040 | 1.089 |
| 750 | 1.036 | 1.083 |
| 800 | 1.031 | 1.073 |
| 850 | 0.992 | 1.062 |
| 900 | 0.949 | 1.050 |

While specific embodiments have been illustrated and described, numerous modifications may come to mind without significantly departing from the spirit of the invention, and the scope of protection is only limited by the scope of the accompanying claims.

What is claimed is:

1. A seal between ceramic electrolyte or mixed electrolyte cells, and ceramic components of similar or dissimilar compositions, ceramic components and metal components, or any other materials for use in electrochemical gas separation devices, fuel cells and other thermal electrochemical power generation devices, high temperature heat exchangers, thermal management devices or other applications requiring joining or gas-tight bonding where said seal is comprised of materials derived from pyrolysis of silicocarbon polymers and fillers of active and/or passive fillers.

2. The seal as recited in claim 1 where pyrolysed silicocarbon polymer material is used as filler alone or in combination with other active and passive fillers.

3. The seal as recited in claim 1 where at least one active filler is selected from the group of Fe, Cu, Ni, Mn, Cr, Ti, TiSi₂, CrSi₂ and combinations thereof.

4. The seal as recited in claim 1 where at least one passive filler is selected from the group of Al₂O₃, ZrO₂, SiC, Si₃N₄ and combinations thereof.

5. The seal as recited in claim 1 where the composition and concentration of fillers is adjusted so as to adjust thermoelastic properties of the material.

6. A method for producing seals or joints involving:
a. Preparing filler material from pyrolysed silicocarbon polymer material;
b. Blending pyrolysed silicocarbon polymer material filler, silicocarbon polymer, solvents, organic additives, and filler materials;
c. Applying said blend to relevant components;
d. Curing blended material; and
e. Pyrolysing material.
